(19) United States
(12) Patent Application Publication
(10) Pub. No.: US 2016/0369941 A1
(43) Pub. Date: Dec. 22, 2016

(54) BOLT-ON ADAPTABLE BRACKET ASSEMBLY FOR PALLET RACKS TO PREVENT WALL DAMAGE AND FLUE SPACE VIOLATIONS

(71) Applicant: ROBERT CONSAUL, SAN CARLAS, CA (US)

(72) Inventor: ROBERT CONSAUL, SAN CARLAS, CA (US)

(21) Appl. No.: 14/745,381

(22) Filed: Jun. 20, 2015

(51) Int. Cl. F16M 13/02; B65G 1/02

(52) U.S. Cl. CPC F16M 13/02; B65G 1/02

(57) ABSTRACT

The general purpose of the new vertical adaptable bracket assembly is to provide a pallet rack load stop system wherein a novel bracket combines with existing beams to easily create a load stop for use on all storage levels of pallet racks. The primary benefit of the new vertical bracket is that it prevents goods stored on pallets from infringing on government-mandated flue space and other regulations related to large-scale storage of product, such as in warehouses. It further serves the purpose of preventing damage to storehouse walls from placement and removal of product from pallet racks.

### FEDERALLY-SPONSORED RESEARCH

Not Applicable.

### SEQUENCE LISTING

Not applicable.

### BACKGROUND OF THE INVENTION

The general purpose of the new bolt-on adaptable bracket assembly is to provide a pallet rack load stop system wherein a novel vertical bracket combines with existing beams to easily create a load stop for use on all storage levels of pallet racks. This invention relates to an improved pallet rack having a safety bracket that is easily and quickly attached to the pallet rack and which is used as a safety barrier to prevent pallets from penetrating government-mandated flue space barriers. The primary benefit of the new bolt-on bracket is that it prevents goods stored on pallets from infringing on government-mandated flue space and other regulations related to large-scale storage of product, such as in warehouses, by preventing wooden pallets from being pushed into the flue space.

The current invention improves on previous products in that it enables easy and inexpensive creation of pallet rack load stops for product on storage pallets to facilitate compliance with fire codes, as well as to prevent damage to walls during placement and removal of pallets of product. Unlike load stop products that focus solely on preventing product from falling off pallet racks, the current bolt-on bracket specifically addresses current and imminent city, county and state government codes regulating flue space clearance and also serves to prevent product loss and warehouse damage.

### SUMMARY OF THE INVENTION

The general purpose of the new bolt-on bracket assembly is to provide a simple, yet versatile and adaptable mechanism for restricting the distance between loaded pallets and vertical flue space. In general, the new horizontal bracket assembly secures at one end to an existing horizontal pallet rack beam via bolting together the flanges of the bracket below the horizontal beam as to prevent removal of the bracket from the beam. At the other end, the bracket assembly connects parallel to a strut beam. The new bolt on vertical bracket can be used alone or attach a strut beam to cover the entire flue space from floor to ceiling. The bracket can also attach to a horizontal strut beam, thereby creating a horizontal load stop.

By attaching perpendicularly to existing horizontal beams, the new vertical bolt-on bracket serves to prevent overhanging pallets, including goods stored thereon, from being positioned too close to a storehouse wall or another rack of pallets. Many government fire codes require a minimum of six (6) inches of clearance between pallets of product and the nearest storage house wall for fire sprinkler effectiveness. Used alone, the bracket restricts an empty or loaded wooden pallet from infringing on required flue space. When the bracket is used with one or more vertical strut beams that span the height of the pallet rack bay—or even horizontal beams that span the width of the pallet rack bay—product is restricted from being pushed off the pallet and into the flue space.

The same is true for pallets of product on racks that are situated back-to-back. Likewise, there must be six inches of clearance between pallets of product on horizontally adjacent rows. One vertical bolt-on load stop bracket, for example, can be used to protect and maintain longitudinal flue space on both sides of pallet racks that are set back-to-back by preventing overhanging pallets and product from being positioned closer than six inches from one another.

The sum of these advantages unify with the novel device for ensuring adequate spacing between pallets and between pallets of product in a storage house, resulting in an invention that is not anticipated, rendered obvious, suggested, or even implied by any of the prior art support, either alone or in any combination thereof.

These, together with other objects of the invention, along with the various features of novelty characterizing the invention, are described with particularity in the claims herewith. A more comprehensive understanding of the features, operation and uses of the invention may be gleaned from reference to the enclosed drawings and descriptive matter further illustrating the preferred embodiments of the invention.

The embodiments described herein are illustrative of the invention, and it is to be understood that the invention is not limited in its application to the details of construction and to the arrangements of the components set forth in the following description and drawings. The invention is capable of other embodiments and of being practiced and carried out in various ways. It should be further understood that the phraseology and terminology applied herein merely serve the purpose of description and should not be regarded as limiting.

### DESCRIPTION OF THE DRAWINGS

FIG. 1 illustrates one embodiment of the new bolt-on bracket assembly.

FIG. 2 illustrates one embodiment of the new bolt-on bracket assembly as attached to a horizontal beam and a single vertical strut channel.

FIGS. 3A-E illustrates the front, back, side, top and bottom views, respectively, of one embodiment of the new bolt-on bracket assembly.

FIG. 4 depicts one embodiment of the new bolt-on bracket assembly as in-use on a pallet rack with pallets of product, the bracket being attached to a horizontal pallet rack beam and a vertical strut channel.

### DETAILED DESCRIPTION OF THE INVENTION

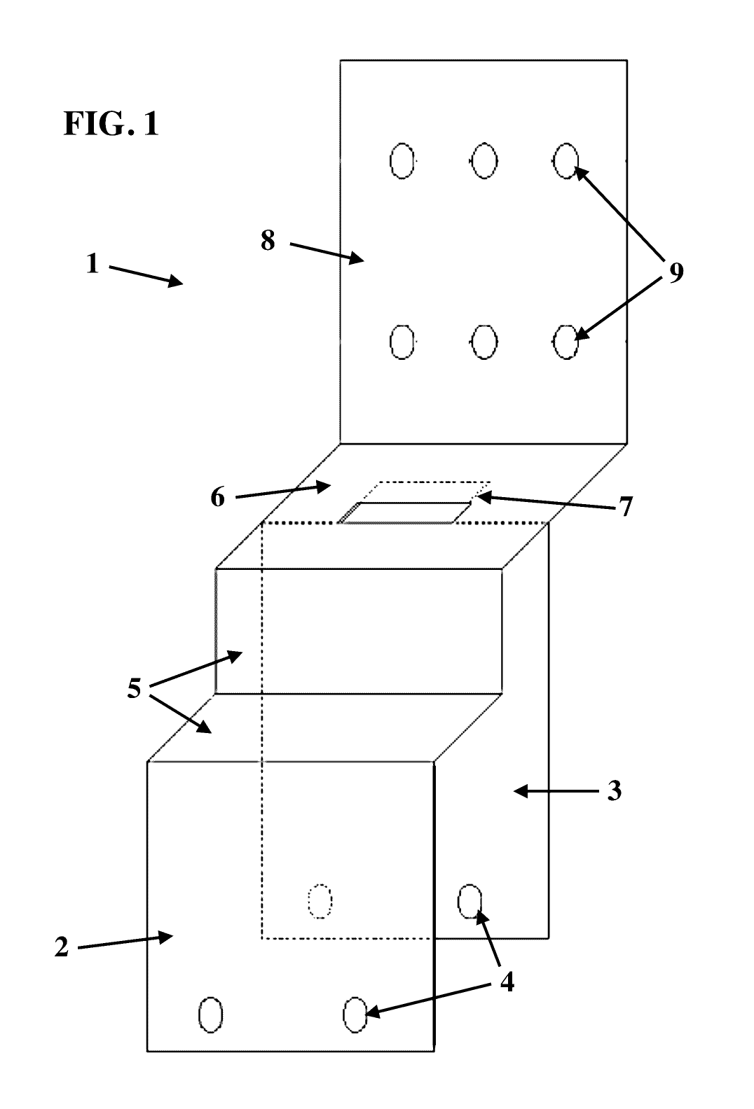

FIG. 1 illustrates one embodiment of the new bolt-on bracket assembly 1 having: an interlocking end with a front flange 2 and a back flange 3, which are parallel to each other and each have two bolt holes 4 identically placed for mounting on a horizontal pallet rack beam; a 90-degree shelf 5, which is designed to enable snug fitting with a horizontal pallet rack beam but is unnecessary to the function of the new bracket; a horizontal plate 6 having an interlock slot 7 for connecting the separate back flange to the bracket for clamping over a pallet rack horizontal beam; and a vertical plate 8 having six mounting holes 9 for mounting one, two or three strut beams as desired. Alternatively, the back flange 3 can be permanently fixed (e.g., welded) to the horizontal plate 6 instead of attached via a tab and interlock slot.

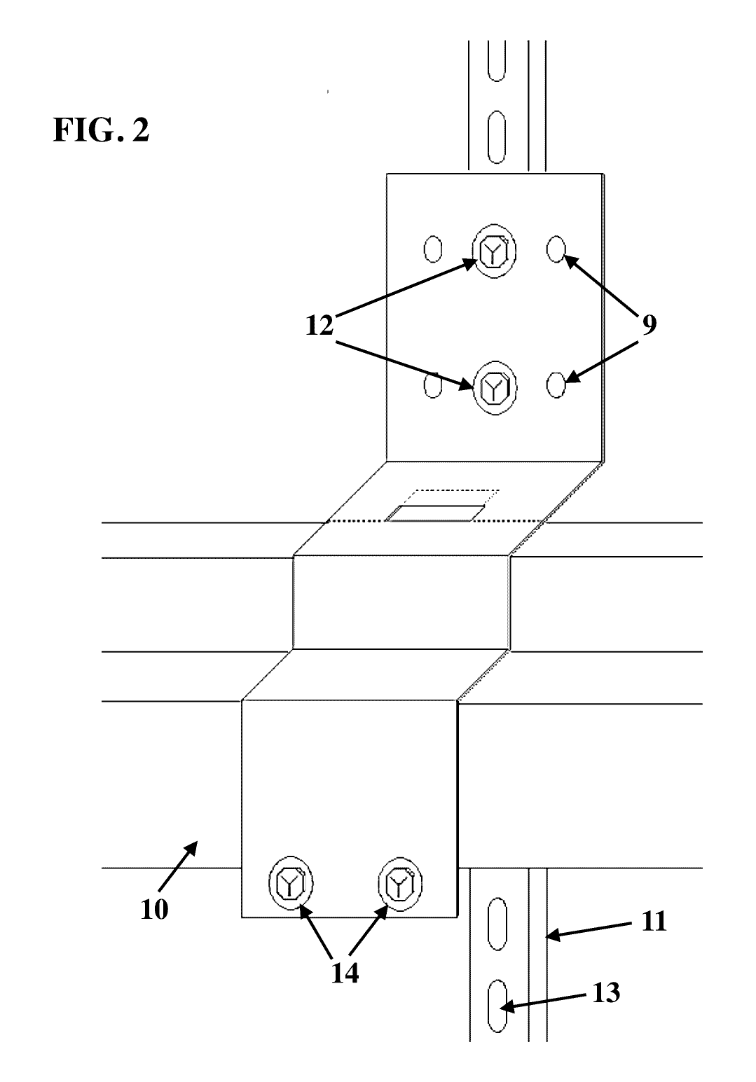

FIG. 2 illustrates one embodiment of the new bolt-on bracket assembly as attached to a horizontal beam 10 and a single vertical strut beam 11. As shown, the bracket attaches to a horizontal beam 10 by two bolts 14 connecting the front and back flanges of the interlocking end of the bracket just beneath the horizontal beam. In this embodiment, the bracket further attaches to a vertical strut beam by two bolts 12 passing through two vertically aligned bolt holes in the vertical plate of the bracket and through two vertically aligned slots 13 in the strut beam 11.

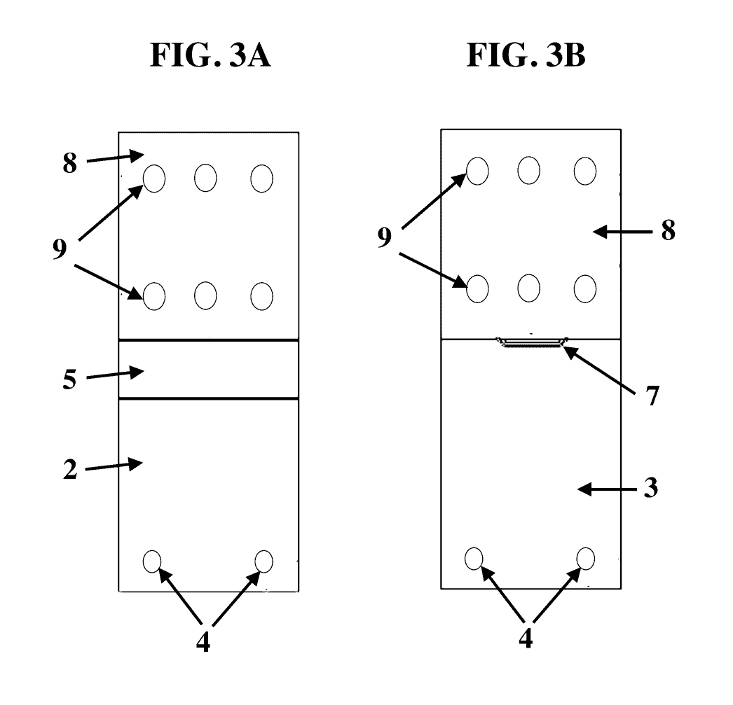

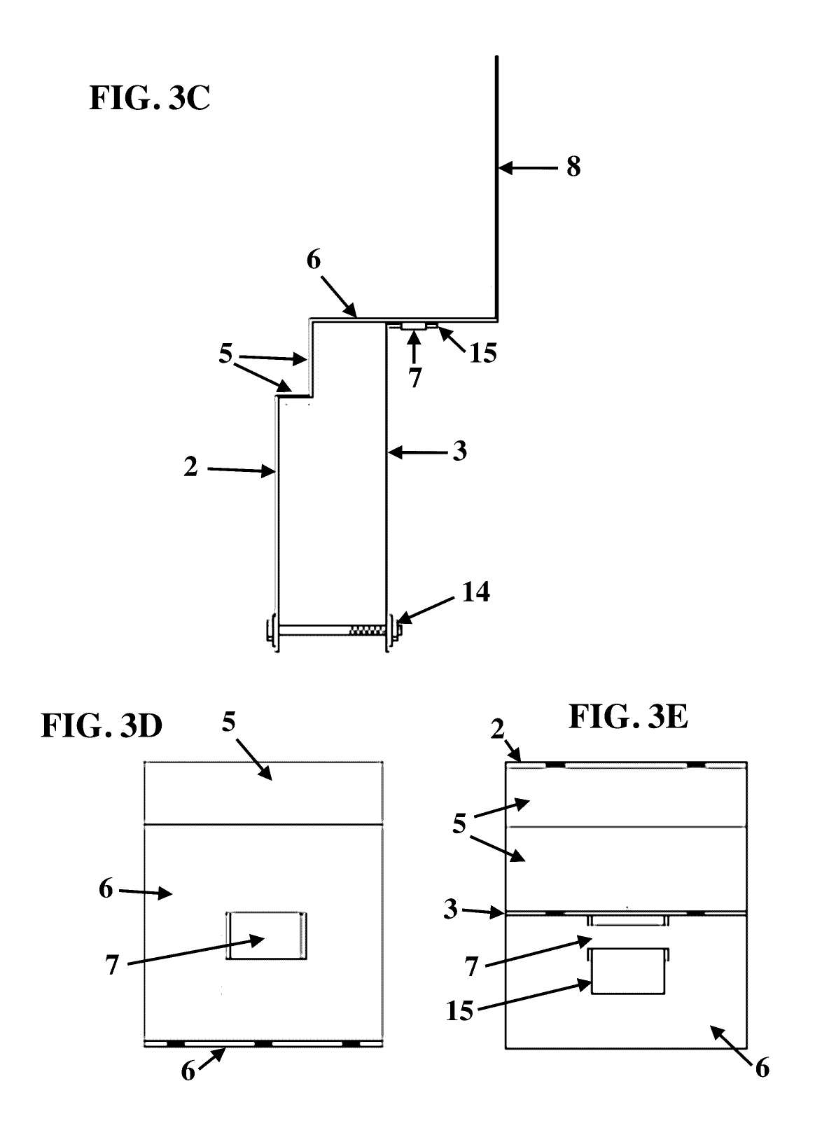

FIGS. 3A-E illustrates the front, back, side, top and bottom views, respectively, of one embodiment of the new bolt-on bracket assembly. FIG. 3A shows the front view of the bolt-on bracket with a front flange 2 having two bolt holes 4, the vertical element of the 90-degree shelf 5, and a vertical plate 8 having six bolt holes 9 for attachment to strut beams as desired. FIG. 3B shows the backside of the bracket having a back flange 3 with two bolt holes 4, an interlock slot 7, and a vertical plate 8 having six bolt holes. FIG. 3C shows the side view of the bolt-on bracket with beam attachment bolts in place, having a bolt 14 connecting a front plate 2 and a back plate 3, a 90-degree shelf 5, a horizontal plate 6 with an interlock slot 7, and a vertical plate 8. The back flange 3 has a 90-degree tab 15 that fits into the interlock slot 7 to enable minor horizontal adjustment of the back flange. FIG. 3D shows the top view of the bracket with a 90-degree shelf 5, a horizontal plate 6 with an interlock slot 7, and a vertical plate 8. FIG. 3E shows the bottom view of the bracket with a front flange 2 and a back flange 3 attached and separated by a 90-degree shelf 5 and a horizontal plate 6 having an interlock slot 7. The 90-degree tab 15 of the back flange 3 is positioned through the interlock slot 7.

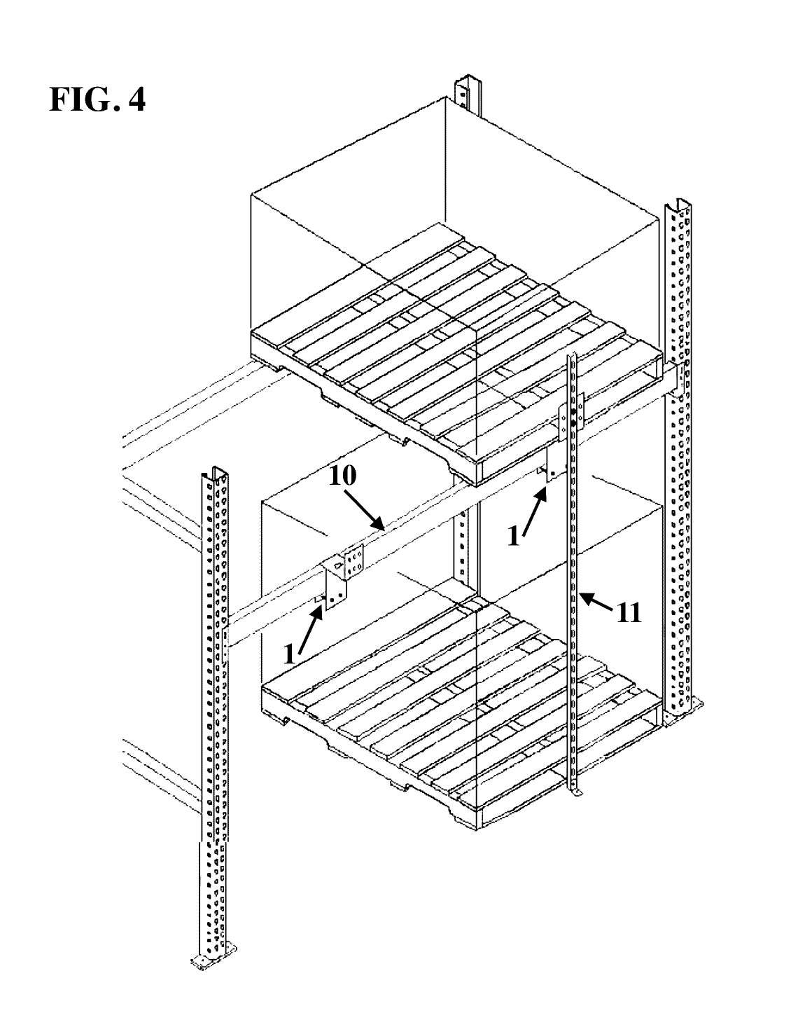

FIG. 4 depicts one embodiment of the new bolt-on bracket assembly as in-use on a pallet rack with pallets of product, the bracket 1 being attached to a horizontal pallet rack beam 10 and a vertical strut channel 11. The bolt-on bracket assembly, as depicted, is used on a pallet rack up against a wall or abutting another pallet rack to protect items and maintain required space between pallets and a wall or other pallets of product for government heath, food safety and fire code requirements.

As to further discussion of the manner of usage and operation of the present invention, the same should be apparent from the above description. With respect to the above description then, it is to be realized that the optimum dimensional relationships for the parts of this invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention, the use of which results in a vertical adaptable bracket assembly for pallet racks.

Although the description presented heretofore contains specificities for the benefit of illustration, these should not be construed as limiting the scope of the embodiments but rather as illustrative examples of some of the several embodiments. Thus, the scope of the embodiments should be determined by the appended claims and their legal equivalents rather than by the examples provided.

What is claimed is:

1. An adaptable bracket assembly for facilitating storehouse flue space and preventing wall damage, comprising:
a first end unit for attachment to a horizontal pallet rack beam, said first end unit having front and back parallel sides positioned at least 3 inches relative to one another, each side being a plate and each said plate having a plurality of holes complimentary to those of the opposing plate, said holes being large enough to accommodate ⅜-inch bolts;
a horizontal attachment plate having a top side and a bottom side, and a near edge and a far edge opposing each other, the first end unit being attached perpendicularly to the bottom side, and parallel to and flush with the near edge, of the horizontal attachment plate; and
a second end unit for attachment to one or more strut channels, said second end unit having a vertical restriction plate attached perpendicularly to the top side, and parallel to and flush with the far edge, of the horizontal attachment plate and having a plurality of holes horizontally spaced 1⅜ inches apart, said holes being large enough to accommodate ⅜-inch bolts.

2. The adaptable bracket assembly of claim 1 wherein the front side plate of the first end unit has first and second 90-degree bends spaced one inch apart and in opposite directions such that the front side plate fits flush with the front side of a horizontal pallet rack beam, said first bend positioned 1½ inch from the top of the front side plate and said second bend occurring 2½ inches from the top of the front side plate.

3. The adaptable bracket assembly of claim 1 further comprising an interlock means, wherein the interlock means is a horizontal slot receptacle oriented perpendicular to the near edge and attached to the bottom of the horizontal attachment plate and positioned generally in the center of the horizontal attachment plate.

4. The adaptable bracket assembly of claim 3 further comprising a tab resulting from a 90-degree bend in the back side plate of the first end unit and wherein the back side plate attaches to the bottom side of the horizontal attachment plate via horizontal insertion of the tab into the interlock means.

5. The adaptable bracket assembly of claim 1 wherein the inner diameter between the front and back side plates of the first end unit is 3 inches and the outer diameter is approximately 3⅛ inches.

6. The adaptable bracket assembly of claim 1 wherein the length of the horizontal attachment plate between the near edge and the far edge is 5⅛ inches.

7. The adaptable bracket assembly of claim 1 wherein the height of the vertical restriction plate is at least 3 inches.

8. The adaptable bracket assembly of claim 1 wherein the height of the vertical restriction plate is 6 inches and the total height of the bracket assembly is 12⅛ inches.

9. The adaptable bracket assembly of claim 1 wherein the width of each of the front and back side plates of the first end unit is 6 inches, the width of the horizontal attachment plate is 6 inches, and the width of the vertical restriction plate is 6 inches.

10. The adaptable bracket assembly of claim 1 wherein the plurality of complementary holes is equal to fourteen holes on each of the parallel plates.
